(19) United States
(12) Patent Application Publication
(10) Pub. No.: US 2019/0375118 A1
(43) Pub. Date: Dec. 12, 2019

(54) UTILITY KNIFE WITH ROTATING HEAD ASSEMBLY

(71) Applicants: Benjamin J. Spotora, Chicago, IL (US); Weston S. Koennecke, Oak Park, IL (US)

(72) Inventors: Benjamin J. Spotora, Chicago, IL (US); Weston S. Koennecke, Oak Park, IL (US)

(21) Appl. No.: 16/435,512

(22) Filed: Jun. 9, 2019

Related U.S. Application Data
(60) Provisional application No. 62/683,138, filed on Jun. 11, 2018.

(51) Int. Cl. B26B 1/04; B26B 5/00; B26B 1/10

(52) U.S. Cl. CPC B26B 1/046; B26B 1/10; B26B 5/006

(57) ABSTRACT

A utility knife is disclosed having a body with a handle portion opposite a head portion and a head assembly received by the head portion of the body. The head assembly of the utility knife is configured to receive and secure a razor blade, wherein the head assembly is configured to pivot with respect to the body such that the razor blade forms an angle with respect to the body.

### CROSS REFERENCE TO RELATED APPLICATIONS

This application claims the benefit of priority to U.S. Provisional Patent Application No. 62/683,138, filed Jun. 11, 2018, which is incorporated by reference herein in its entirety.

### TECHNICAL FIELD

The present invention relates to a utility knife, and more particularly, a utility knife having a rotating head assembly that pivots or rotates to adjust the angle of the knife blade with respect to a utility knife body.

### BACKGROUND

Utility knives are well known. Most conventional utility knives comprise a case or handle for holding a standard razor blade in which the razor blade is in a fixed position. Typically, the case is held together by a single, centrally-located screw or by integrated features within the case. In this arrangement, the blade remains in a fixed position with respect to the case or handle.

One improvement upon a fixed utility knife is one in which the blade slides or otherwise protrudes from or retracts within the utility knife case or handle. With such a retracting knife, a user holding the utility knife may actuate the razor blade by pressing and sliding with a thumb or other digit a slider connected to the slide assembly, which causes the razor blade to protrude from an end of the case. Utility knives of this fashion often are referred to as “Stanley” knives because of those manufactured and sold by the Stanley Company.

Another type of utility knife, often referred to as a “carpet knife” because of its use with carpet installation, maintains the razor blade at about a forty-five degree angle downward with respect to the handle of the knife. An example of a typical carpet knife is disclosed in U.S. Patent Application Publication No. 2011/0271531 to Huang. As shown in the Huang Publication, a user may gain access to the razor blade by loosening the central screw (70) and rotating one half of the case (10, 20), as generally shown in the Huang Publication, FIG. 1.

Other types of utility knives combine a conventional utility knife with a conventional switchblade knife, in which the razor blade rotates downwardly with respect to the handle and retracts within the handle for safe storing. This type of utility knife sometimes is referred to as a folding utility knife. Examples of such safety utility knives are disclosed in U.S. Pat. No. 6,915,577 to Scala and U.S. Patent Application Publication No. 2012/0030949 to Ping.

Presently, no prior art utility knives provide for lateral rotation of the razor blade with respect to the handle. As a result, adjusting blade angles for various cutting applications is not possible, and using any of the conventional utility knives described herein may be difficult and suboptimal in such applications.

### SUMMARY OF THE INVENTION

According to one non-limiting aspect of the present disclosure, a utility knife is disclosed having a body with a handle portion opposite a head portion and a head assembly received by the head portion of the body. The head assembly of the utility knife is configured to receive and secure a razor blade, wherein the head assembly is configured to pivot with respect to the body such that the razor blade forms an angle with respect to the body.

According to another non-limiting aspect of the present disclosure, an example embodiment of a method for adjusting or angling a razor blade of a utility knife is disclosed. The method includes the steps of providing a handle portion secured to an end of the body proximate the razor blade; providing a head assembly received by the head portion of the body, the head assembly being configured to receive and secure the razor blade; and pivoting the head assembly with respect to the body such that the razor blade forms an angle with respect to the body.

Additional features and advantages are described herein, and will be apparent from the following Detailed Description and the figures.

### BRIEF DESCRIPTION OF THE DRAWINGS

Features and advantages of the utility knife described herein may be better understood by reference to the accompanying drawings in which:

FIG. 1 depicts a side view of an exemplar of a utility knife of the present disclosure, along with orthographic projections of the exemplar showing front and back views;

FIG. 2A depicts a sectional view of the exemplar utility knife of FIG. 1, with the rotating head assembly in a locked or engaged position;

FIG. 2B depicts side and sectional views of the exemplar utility knife of FIG. 1, with the rotating head assembly in an unlocked or disengaged position;

FIG. 2C depicts close-up sectional views of the side view of the exemplar utility knife in the unlocked and locked positions;

FIG. 3A depicts a top view of the exemplar utility knife of FIG. 1, with the rotating head assembly shown in a position rotated counterclockwise with respect to the body, in a neutral or default position, in a position rotated clockwise with respect to the body, and in a closed or stowed position;

FIG. 3B depicts a side view of the exemplar utility knife of FIG. 3A, in the same positions as shown in FIG. 3A;

FIG. 4 depicts an exploded view of the exemplar utility knife of FIG. 1;

FIG. 5A depicts a side view of the razor blade locking mechanism of the exemplar utility knife of FIG. 1 with the razor blade engaged and locked;

FIG. 5B depicts a side view of the razor blade locking mechanism of the exemplar utility knife of FIG. 1 with the razor blade removed; and

FIG. 5C depicts perspective views of the razor blade locking mechanism.

The reader will appreciate the foregoing details, as well as others, upon considering the following Detailed Description of certain non-limiting embodiments of the utility knife according to the present disclosure. The reader may also comprehend certain of such additional details upon use of the utility knife described herein.

### DETAILED DESCRIPTION

The present disclosure, in part, is directed to a utility knife having a rotating head assembly.

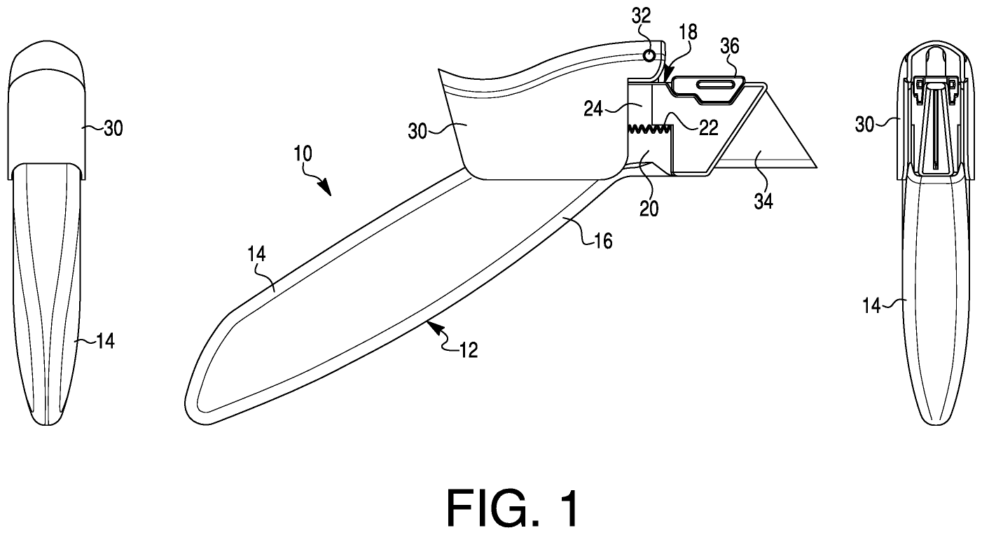

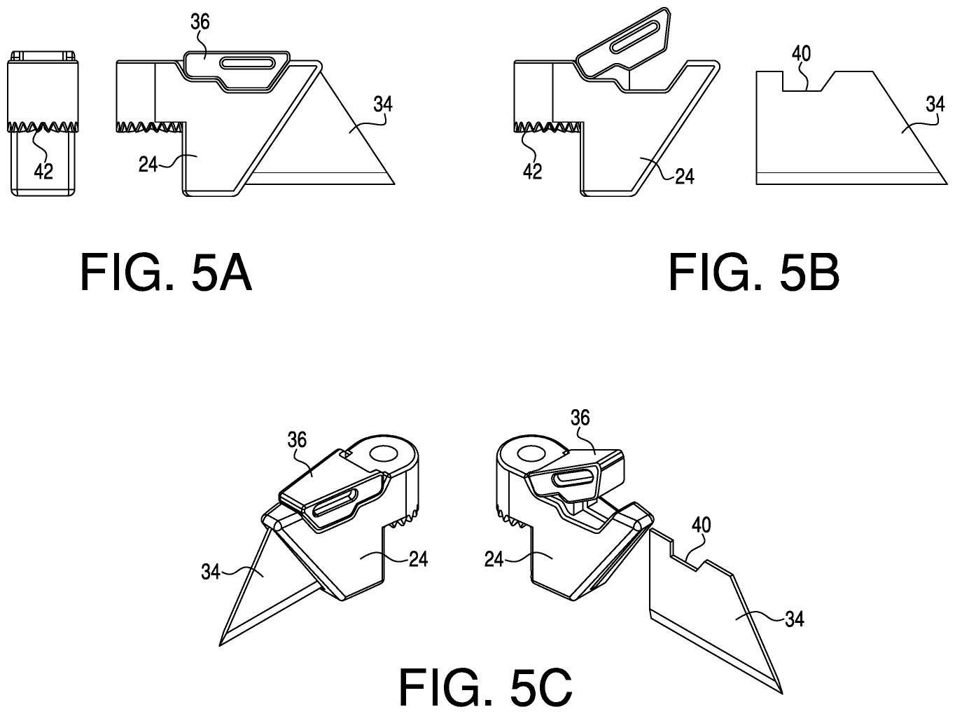

As shown in FIG. 1, a utility knife (10) is disclosed having a body (12) with a grip or handle portion (14) opposite a head portion (16), which is configured to receive and retain a head assembly (18). The head assembly (18) is received by a shoulder portion (20) affixed to or integrated within the head portion (16) of body (12). The shoulder (20) includes a plurality of teeth (22) on an upper surface, which interfaces with a mating surface (42, FIG. 5C) to limit or control rotary motion of the head assembly (18) with respect to the body (12).

Head assembly (18) includes a frame (24) that is received by shoulder (20) and is secured to the shoulder via post (26). Post (26) is mounted or secured to the head portion (16) and passes through the center of shoulder (20). Post (26) also passes through and retains spring (28), which works to compress the frame (24) of head assembly (18) against the shoulder (20) when the locking mechanism (30) is moved to an engaged or locked position.

Locking mechanism (30) is connected to post (26) via pin (32). Locking mechanism (30) rotates about pin (32) to move from a locked or engaged position upwardly to an unlocked or disengaged position. Moving locking mechanism (30) upwardly with respect to head portion (16) releases spring (28). By releasing spring (28), frame (24) is disengaged from toothed surface (22) of shoulder (20), such that frame (24) is free to rotate or pivot with respect to head portion (16) based on rotation about post (26). Rotating locking mechanism (30) downwardly with respect to head portion (16) energizes spring (28) and compresses frame (24) against the toothed surface (22) of shoulder (20).

Frame (24) also receives and retains razor blade (34). Razor blade (34) slides within frame (24) and is secured by blade retaining member (36). In specific, razor blade (34) slides within frame (24), and retaining member (36) rotates or pivots downwardly to engage recess (40, FIG. 5C) along the top edge of blade (34).

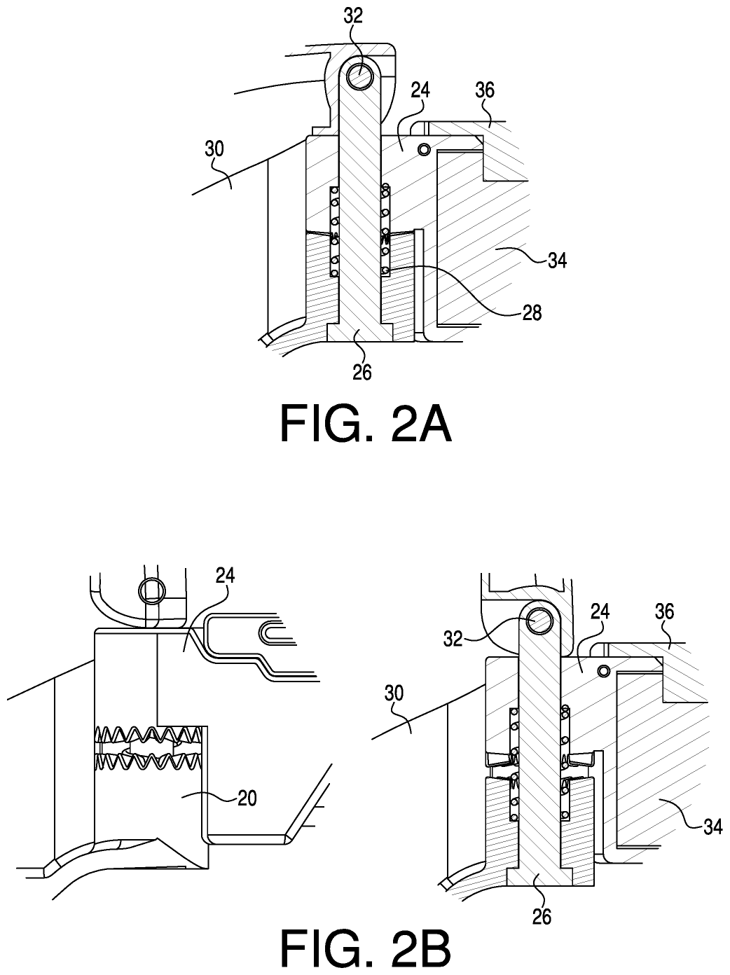

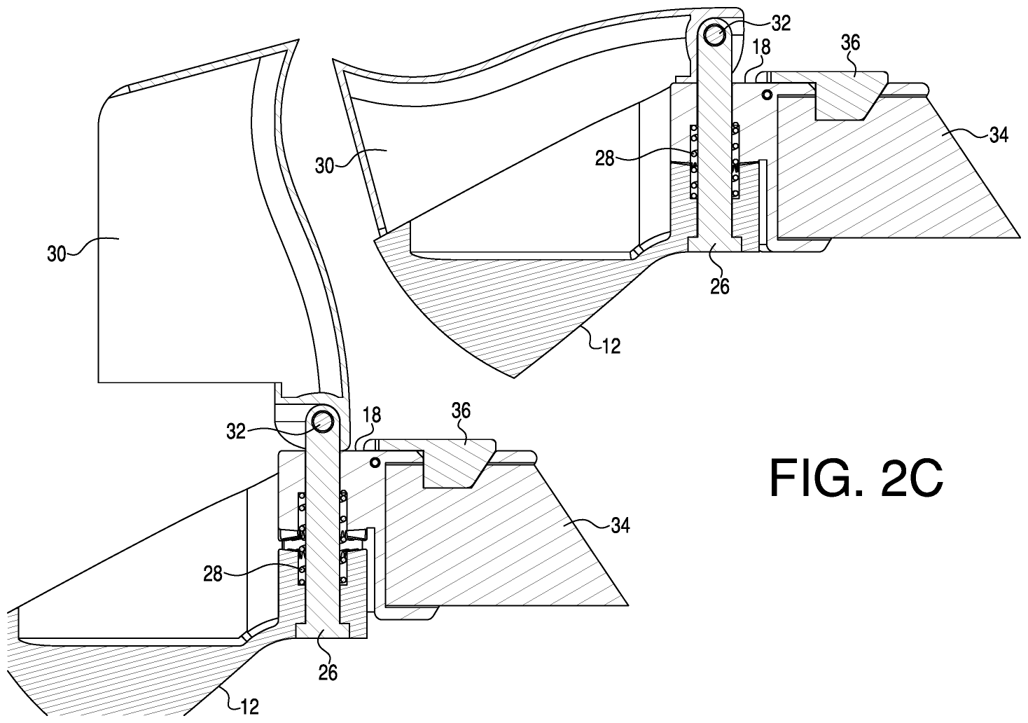

The locking mechanism (30) is shown in a locked or engaged position in FIG. 2A and in an unlocked or disengaged position in FIG. 2B. In the locked or engaged position, as shown in detail in FIG. 2A, locking mechanism (30) is shown in a downward position, which energizes spring (28) to slightly compress the frame (24) against the shoulder (20). The frame (24), and specifically mating surface (42, FIG. 5C), is driven slightly downward into toothed surface (22) of shoulder (20), thereby preventing any rotational movement of frame (24) with respect to the body (12). In the locked position, the razor blade (34) remains stationary. A user places the utility knife (10) in the locked position prior to use.

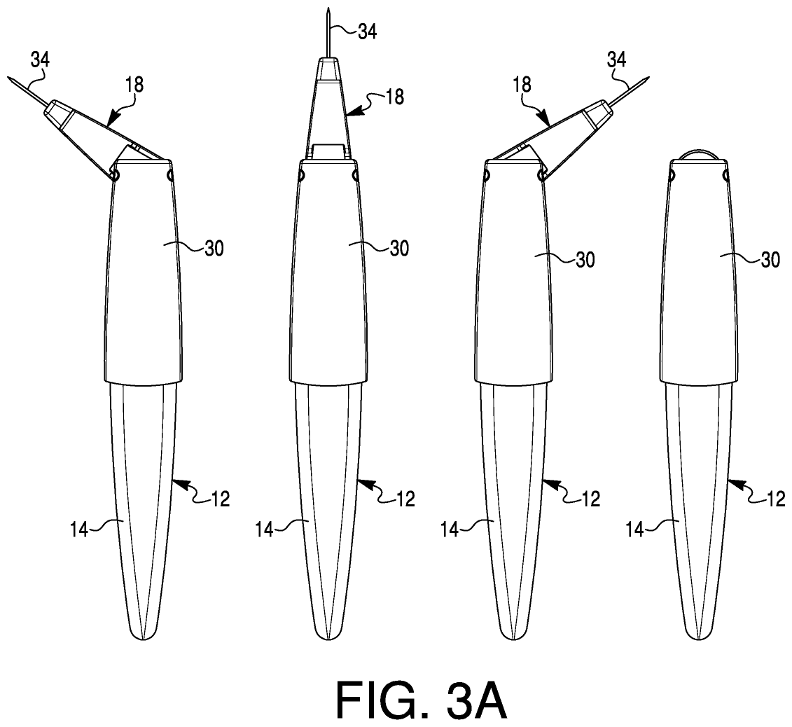

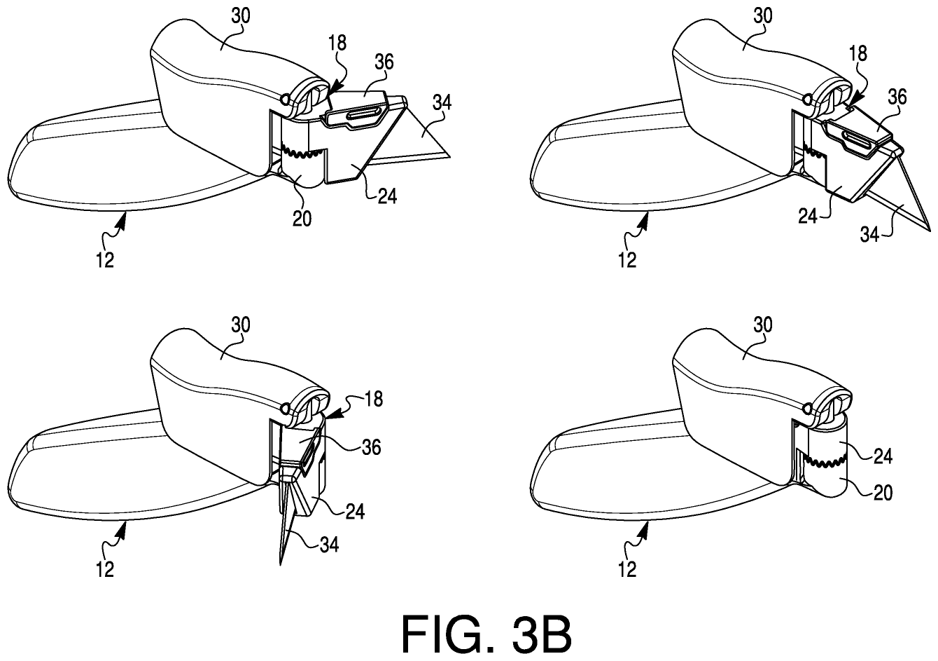

In the unlocked or disengaged position, as shown in detail in FIG. 2B, the locking mechanism (30) has been lifted upward with respect to the body (12). By lifting the locking mechanism (30) upward, spring (28) is released, thereby slightly lifting frame (24) upwardly with respect to shoulder (20). As a result, the frame (24) becomes free to rotate or pivot about post (26) with respect to body (12). A user may unlock or disengage locking mechanism (30) in order to adjust the angle or direction of razor blade (34), or to stow the blade in a closed position, as illustrated in FIG. 3.

FIG. 2C shows sectional views of the head assembly (18) when the locking mechanism (30) is in an engaged or locked position vis-à-vis when the locking mechanism is in an disengaged or unlocked position, which illustrates how the spring (28) releases as the locking mechanism (30) is raised to the unlocked position, thereby lifting frame (24) upwardly slightly with respect to shoulder (22) and body (12). Raising locking mechanism (30) to release spring (28) creates a clearance between the frame (24) and the shoulder (20) to allow the frame (24) to rotate or pivot about post (26), thereby allowing head assembly (18) and blade (34) to rotate with respect to body (12).

As shown in FIGS. 3A and 3B, the head assembly (18) is shown rotated in a counterclockwise direction with respect to body (12), in a neutral or default position in which the head assembly (18) is in the same plane as body (12), and shown rotated in a clockwise direction with respect to body (12). Head assembly (18) is shown rotated about fifty-four degrees in a counterclockwise direction, and about fifty-four degrees in a clockwise direction, though the particular angle selected by the user is dictated by the specific application of utility knife (12). Once a user selects the desired positioning of the head assembly (18) and razor blade (34), the user may depress the locking mechanism (30) to secure the head assembly in that position. A user may desire to rotate head assembly (18) in a desired direction with respect to the body (12) to permit the razor blade (34) to access a particular tight corner or work area. An example where a user may desire to rotate head assembly (18) is with window glazing applications, to achieve a desired angle when cutting or shaping the glazing.

As shown in FIGS. 3A and 3B, the head assembly (18) also may be placed in a neutral or default position, such that the razor blade (34) is aligned in the same plane as the body (12). In the neutral position, the utility knife (10) may be used in any application typical of utility knives, such as box cutting or carpentry. Head assembly (18) also may be rotated one-hundred and eighty degrees in a clockwise direction from the neutral or default position in order to stow razor blade (34) in a closed or storage position, as shown in FIGS. 3A and 3B. A user stows blade (34) by lifting the locking mechanism (30), rotating head assembly (18) one-hundred and eighty degrees clockwise until blade (34) contacts the head portion (16) of body (12), and then depresses locking mechanism (30) to close down upon the blade (34) and prevent rotational movement of the head assembly (18). Locking mechanism (30) is generally U-shaped to house the head assembly (18) when placed into the closed or stowed position.

In an alternative embodiment, shoulder (20) is comprised of a resilient or compressible material, such as rubber or neoprene. In this embodiment, when a user moves the locking mechanism (30) to a locked or engaged position, frame (24) is driven into the compressible shoulder (20), which compresses slightly to form a tight seal against frame (24), thereby preventing rotational movement of the head assembly (18). Compressible shoulder (20) may achieve a tight seal against frame (24) by being slightly oversized such that frame (24) sufficiently compresses shoulder (20) in the locked or engaged position to create enough friction against mating surface (42, FIG. 5C) of frame 24 to overcome rotational forces placed on the head assembly (18) by razor blade (34) during use. Compressible shoulder (20) also may achieve a tight seal by having a plurality of ridges or other features in the upper surface (22) of shoulder (20) that align with or compress against mating surface (42) of frame (24). Because of the resilient nature of compressible shoulder (20), a toothed surface likely would not be necessary or feasible on upper surface (22). Likewise, skilled artisans would appreciate that mating surface (42) may be smooth or have features other than a plurality of teeth (as shown for illustrative purposes in FIG. 5C) when adapted for use with compressible shoulder (20).

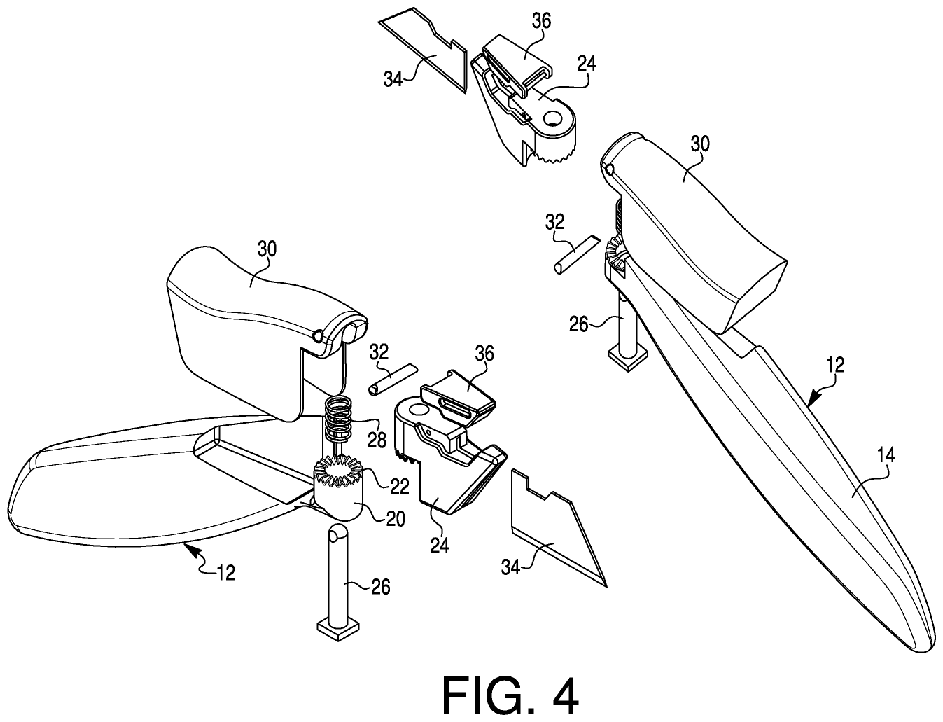

FIG. 4 depicts an exploded view of the components of utility knife (10), which more clearly shows how each of the components interact with one another. The components may be made of many conventional materials. For example, body (12), shoulder (20), frame (24), and locking mechanism (30) may be fashioned of metals such as aluminum or steel or of a durable plastic, composite, or other polymer. Shoulder (20) also may be comprised of a resilient or compressible material, such as rubber or neoprene. In most applications, blade (34) is made of metal, such as steel or stainless steel, though may be fashioned from any hard surface suitable for cutting.

As shown in FIG. 5, razor blade (34) is uniquely shaped and sized to be received by frame (24) of head assembly (18). Blade (34) slides into an interior cavity of frame (24), and retaining member (36) engages recess (40) of blade (34) to secure the blade within the frame. Frame (24) has a mating surface (42) that is configured to engage with the toothed surface (22) of shoulder (20) when the locking mechanism (30) is depressed or moved downwardly with respect to the body (12).

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended representative claims.

What is claimed is:

1. A utility knife comprising:
a body having a handle portion opposite a head portion;
a head assembly received by the head portion of the body, the head assembly being configured to receive and secure a razor blade;
wherein the head assembly is configured to pivot with respect to the body such that the razor blade forms an angle with respect to the body.

2. The utility knife of claim 1 further comprising a locking mechanism that prevents the head assembly from pivoting with respect to the body.

3. The utility knife of claim 2 wherein the locking mechanism comprises a base member having a plurality of teeth that engage the head assembly to prevent the head assembly from pivoting with respect to the body.

4. The utility knife of claim 2 wherein the locking mechanism comprises a base member having a compressible surface that engages the head assembly to prevent the head assembly from pivoting with respect to the body.

5. The utility knife of claim 2 wherein the locking mechanism is activated by the handle portion, such that raising the handle portion with respect to the body unlocks the locking mechanism.

6. The utility knife of claim 3 wherein the base member engages the head assembly when the handle portion is lowered against the body.

7. The utility knife of claim 4 wherein the base member engages the head assembly when the handle portion is lowered against the body.

8. The utility knife of claim 1 wherein the head assembly pivots such that the razor blade forms an angle with respect to the body up to ninety degrees, when the utility knife is being used as a knife.

9. The utility knife of claim 1 wherein the head assembly pivots one-hundred and eighty degrees such that the razor blade may be stowed within a recess of the body.

10. The utility knife of claim 1 wherein the locking mechanism includes a spring-loaded member for engaging the head assembly.

11. A method for cutting at an angled direction with a utility knife having a body with a head portion securing a razor blade that is configured to pivot with respect to the body, the method comprising the steps of:
providing a handle portion secured to an end of the body proximate the razor blade;
providing a head assembly received by the head portion of the body, the head assembly being configured to receive and secure the razor blade; and
pivoting the head assembly with respect to the body such that the razor blade forms an angle with respect to the body.

12. The method of claim 11 further comprising the steps of providing a locking mechanism operatively connected to the head assembly, and engaging the locking mechanism to prevent the head assembly from pivoting with respect to the body.

13. The method of claim 12 wherein the locking mechanism includes a base member having a plurality of teeth, the teeth engaging the head assembly to prevent the head assembly from pivoting with respect to the body.

14. The method of claim 12 wherein the locking mechanism includes a base member having a compressible surface, the compressible surface engaging the head assembly to prevent the head assembly from pivoting with respect to the body.

15. The method of claim 12 wherein the locking mechanism is activated by the handle portion, such that raising the handle portion with respect to the body unlocks the locking mechanism.

16. The method of claim 13 wherein the base member engages the head assembly when the handle portion is lowered against the body.

17. The method of claim 14 wherein the base member engages the head assembly when the handle portion is lowered against the body.

18. The method of claim 11 wherein the head assembly pivots such that the razor blade forms an angle with respect to the body up to ninety degrees, when the utility knife is being used as a knife.

20. The method of claim 11 wherein the head assembly pivots one-hundred and eighty degrees such that the razor blade may be stowed within a recess of the body.
